(19) United States
(12) Patent Application Publication
(10) Pub. No.: US 2009/0117452 A1
(43) Pub. Date: May 7, 2009

(54) Rechargeable Battery Pack and Electrical Hand Tool Device

(76) Inventors: Bernd Wiesner, Owen (DE); Ralph Liersch, Metzingen (DE); Wolfgang Stickel, Beuren (DE)

Correspondence Address: DREISS, FUHLENDORF, STEIMLE & BECKER, POSTFACH 10 37 62, D-70032 STUTTGART, DE

(21) Appl. No.: 11/991,623

(22) PCT Filed: Sep. 21, 2005
(86) PCT No.: PCT/EP2005/010206

§ 371 Date: Mar. 7, 2008

(51) Int. Cl. H01M 10/48

(52) U.S. Cl. 429/90

(57) ABSTRACT

A rechargeable battery pack (10) of an electrical hand tool device comprises at least one rechargeable battery cell (16) and a temperature sensor (30) for measuring the temperature of at least one rechargeable battery cell (16), wherein a spring element (32) is provided which subjects the temperature sensor (30) to a load in the direction of at least one rechargeable battery cell (16).

The invention concerns a rechargeable battery pack and an electrical hand tool device in which the rechargeable battery pack may be used.

Rechargeable battery packs of this type are rechargeable batteries for electrically operated devices. These include, in particular, electrical hand tool devices. When electrical hand tool devices are used on building sites, the use of rechargeable battery-operated tools is advantageous, since they require no cables and, in particular, no extension cables, and therefore there is no danger that the cable is damaged by the tool.

In general, several rechargeable batteries or rechargeable battery cells are thereby combined into rechargeable battery packs that can be easily attached to the tool.

The rechargeable battery packs are usually disposed in a rechargeable battery housing that can be coupled to the device housing of the electrical hand tool device, wherein, when the two housings are coupled, the motor is electrically coupled to the rechargeable battery pack and thereby provided with current. The rechargeable battery housing usually comprises a protruding locking device, which is inserted into and locked in a complementary insertion bushing of the device housing for coupling the two devices. The electric contact is thereby usually provided in the area of the locking device. When the rechargeable battery has been discharged, it can be replaced by another rechargeable battery or the device may be immediately charged. The empty rechargeable battery can, in particular, be inserted into a charging device in order to be recharged. The charging time is preferentially particularly short in order to reduce the inoperative time of the rechargeable battery.

The charging of a rechargeable battery is dependent on its temperature. If the temperature of a rechargeable battery pack is too high, its current storing capacity decreases.

It is therefore desired to determine the temperature of a rechargeable battery pack. For this reason, rechargeable battery packs are often provided with temperature sensors. DE 42 34 231 A1 discloses e.g. a rechargeable battery comprising a temperature sensor that switches off the rechargeable battery when a predetermined temperature has been reached. The rechargeable battery stops to supply current although it has not been completely discharged. Since there is no rechargeable battery cooling time, immediate recharging is possible. Despite the shorter discharging time, the rechargeable battery is operative for a longer time period. The temperature of the rechargeable battery cells is determined by the temperature sensor.

The temperature sensors are normally disposed at some location in the rechargeable battery pack that enables contact with at least one cell wall. Since the temperature sensors are conventionally loosely fitted into the rechargeable battery pack, there is always a small clearance or an air gap between the surface of the temperature sensor and the neighboring cell. In consequence thereof, the measured temperatures are falsified by the intermediate air cushion.

It is therefore the underlying purpose of the invention to provide a rechargeable battery pack and an electrical hand tool device, in which a temperature sensor can be disposed in a simple fashion such that the temperature can be measured with maximum precision.

This object is achieved in accordance with the invention by a rechargeable battery pack of the above-mentioned type, wherein the temperature sensor is loaded by a spring element towards at least one rechargeable battery cell. The inventive object is also achieved by an electrical hand tool device comprising a corresponding rechargeable battery pack.

This design is advantageous in that the temperature sensor always rests against at least one rechargeable battery cell due to the spring pretension. This is achieved even when the rechargeable battery pack is subjected to a load due to movement and oscillations e.g. of an electrical hand tool device, e.g. a percussion drill or a hammer drill. The spring element may thereby be designed to ensure that the temperature sensor rests against a rechargeable battery cell in any operating state and beyond, within a certain safety range.

The temperature sensor may also rest against the wall of two rechargeable battery cells. The temperature sensor may, in particular, be thereby urged into a space between two rechargeable battery cells, such that it is in contact with the walls of two rechargeable battery cells. In this fashion, the cell temperature can be detected with even more precision.

Moreover, the temperature sensor may be directly connected to a corresponding monitoring electronics. The temperature sensor may, in particular, be directly soldered into the monitoring electronics. A connector system is not required in this case and the electronics can be tested together with the temperature sensor. The monitoring electronics is thereby advantageously part of the existing rechargeable battery electronics.

Mounting of the temperature sensor is moreover considerably facilitated by providing a spring element. Dismounting is also possible. Mounting can be effected without auxiliary tool or glue. The cooling air flow that flows through a rechargeable battery pack is therefore not disturbed, in contrast e.g. to glued temperature sensors, in order to prevent unnecessary and limitable heating of the rechargeable battery cells.

In accordance with the invention, the spring element may be a shackle, in particular, a plastic shackle. This shackle may, in particular, be connected in one piece to a cell holder, which is usually also a plastic part. The cell holder thereby receives and separates the individual rechargeable battery cells in order to prevent short-circuits. Rechargeable battery cells and cell holders form together the so-called core pack. This considerably facilitates the production of the components. No further mounting of the spring shackle is required when it is designed as part of the cell holder. The spring shackle is thereby formed, in particular, by a rod-like plastic element that is fixed on one side.

The cell holder could basically also comprise an opening for receiving the temperature sensor or the spring element. This opening may, in particular, be adjusted to the temperature sensor and be used to guide and hold it. The temperature sensor could be inserted via the opening into the cell holder and then be loaded by the spring element towards at least one rechargeable battery cell. The temperature sensor could be directly mounted (only) during final assembly of the rechargeable battery. It could then be connected to the monitoring electronics via strands.

The monitoring electronics for the rechargeable battery pack may be housed in the rechargeable battery pack itself. This permits preassembly of the entire rechargeable battery pack and moreover also testing of the rechargeable battery pack without having to insert it into an electrical hand tool device.

With particular advantage, the rechargeable battery cells are lithium cells. Lithium cells are highly advantageous compared to conventional rechargeable battery cells in view of the available time period during which they can discharge energy e.g. to an electric tool. Lithium cells are also advantageous in view of their service life, since the memory effect is not that distinct.

The invention also concerns an electrical hand tool device comprising a rechargeable battery pack as described above for supplying electric energy to an electric motor of the electrical hand tool device, wherein the rechargeable battery back can be detachably locked with the electrical hand tool device.

Further advantages and features of the invention can be extracted from the claims and the drawing. The invention is explained in more detail below with reference to the drawing.

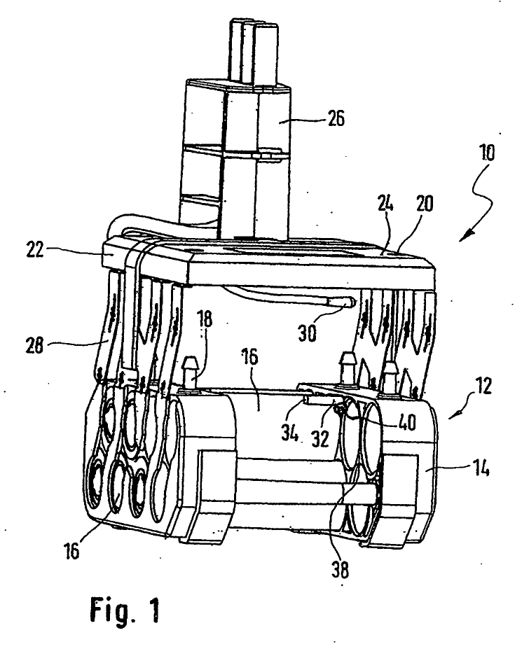

FIG. 1 shows a perspective view of a rechargeable battery pack;

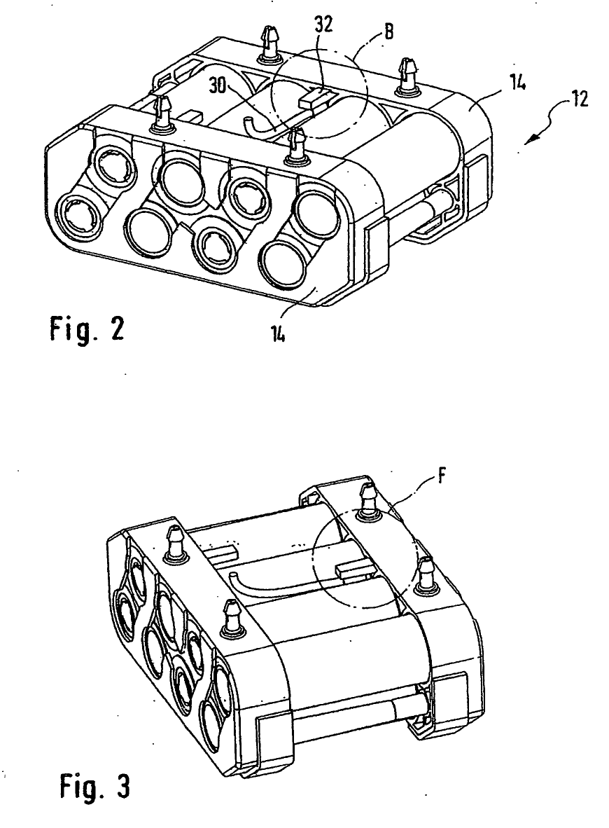

FIG. 2 shows a first view of a core pack of the rechargeable battery pack according to FIG. 1;

FIG. 3 shows a second view of the core pack of the rechargeable battery pack according to FIG. 1;

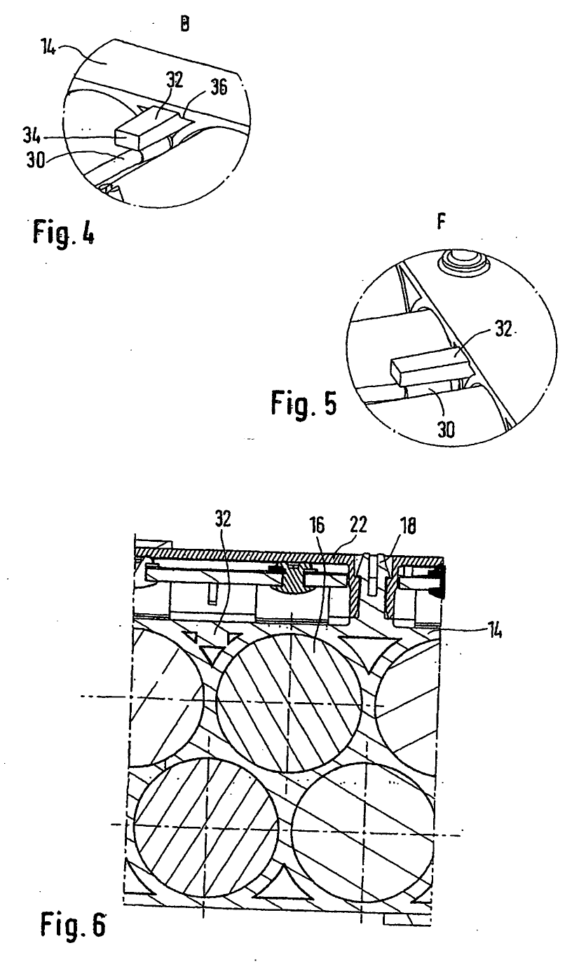

FIG. 4 shows the detail B of FIG. 2;

FIG. 5 shows the detail F of FIG. 3;

FIG. 6 shows a section through the rechargeable battery pack of FIG. 1.

FIG. 1 shows a rechargeable battery pack, which is designated in total with reference numeral 10. The outer rechargeable battery housing that surrounds the rechargeable battery pack 10 is thereby not shown. The rechargeable battery pack comprises a core pack 12 comprising a cell holder 14 and rechargeable battery cells 16, wherein the present cell holder 14 can receive eight rechargeable battery cells 16. The first three rechargeable battery cells 16 (in the direction of view) are not illustrated for a better view of the temperature sensor described below.

Two rechargeable battery cells 16, i.e. the rechargeable battery cells 16 disposed on top of each other, are thereby connected in parallel in each case. The rechargeable battery cells 16 of the lithium cells to be used in accordance with the invention, can be connected in parallel in contrast to rechargeable nickel cadmium battery cells.

The respective cell pairs that are connected in parallel are then disposed behind each other in a series connection. In the present case, this means that four rechargeable battery pairs are connected in series in each case.

The rechargeable battery cells 16 are accommodated in the cell holder 14 in such a fashion that short-circuits as well as mechanical damage both to the electric contacts and to the rechargeable battery cells 16 themselves is prevented. The cell holder 14 moreover comprises connecting elements 18 that engage in corresponding recesses 20 in an electronic housing 22 of the rechargeable battery pack 10. In the present case, the electronic housing 22 accommodates the monitoring electronics (not shown) which can be solidly cast, in particular, into the electronic housing 22 in order to protect it from shocks etc. The connecting dome 26, for later electrical connection and mechanical coupling to an electrical hand tool device, is moreover provided on the upper side 24 of the electronic housing. The electronic housing 22 and core pack 12 are joined via a positive locking connection. The electronic housing 22 also already comprises connecting elements 28 that can be connected to the individual rechargeable battery cells 16 at a later time to provide electric contact among the rechargeable battery cells 16 and also connect the rechargeable battery cells 16 to the monitoring electronics. A temperature sensor 30 is moreover disposed directly on the electronics, which can be disposed onto the core pack 12 together with the monitoring electronics. The temperature sensor is thereby at least partially flexible and has a rod-shaped design which is fixed at one end to the electronics.

The core pack 12 moreover comprises a spring element 32 in the area of the temperature sensor 30, which is designed in one piece with the cell holder 14 of the core pack 12. The spring element 32 is a formed-on resilient plastic shackle that comprises a free end 34 and a fixed end 36 via which it merges into the cell holder 14. The spring characteristics of the spring element 32 thereby depend on the cross-sectional shape of the spring element, on the material used, and also on the length of the spring element 32. An opening 40 is indicated with a circle below the spring element 32, which could have an additional guiding function for the temperature sensor 30 (this is not realized in the present case). The opening could also be used to mount the temperature sensor 30 and secure it against displacement or oscillations in the rechargeable battery pack 10.

FIGS. 2 and 3 show different views of the core pack 12 with cell holder 14 and attached spring element 32. The temperature sensor 30 is also (partially) shown for clarification.

FIGS. 4 and 5 show sections of FIG. 2 and FIG. 3, i.e. the details characterized by B and F, respectively, illustrating the spring shackle 32 and the temperature sensor 30. The spring shackle 32 ensures that the temperature sensor 30 is directly pressed against the wall of a rechargeable battery cell 16 and contacts this wall to provide good thermal contact.

FIG. 6 shows a sectional view in accordance with FIG. 2 and FIG. 3, however, with the electronic housing 22 being mounted. It shows the spring element 32 that is connected in one piece with the cell holder 14. In this fashion, a rechargeable battery pack 10 can be provided, in particular, for an electrical hand tool device, which ensures exact detection of the cell temperature without interference of an air cushion formed between the temperature sensor 30 and the wall of the rechargeable battery cells 16.

1-5. (canceled)

6. A rechargeable battery pack for an electrical device, the battery pack comprising:
at least one rechargeable battery cell;
a temperature sensor for measuring a temperature of said at least one rechargeable battery cell;
a plastic cell holder for receiving and holding said at least one rechargeable battery cell; and
a plastic spring element tab cooperating with said cell holder, said spring element tab structured and disposed to urge said temperature sensor towards said at least one rechargeable battery cell.

7. The rechargeable battery pack of claim 6, wherein said spring element tab is integral with said cell holder.

8. The rechargeable battery pack of claim 6, wherein said spring element tab urges said temperature sensor against a wall of said at least one rechargeable battery cell.

9. The rechargeable battery pack of claim 6, wherein said spring element tab urges said temperature sensor against a wall of at least two rechargeable battery cells.

10. The rechargeable battery pack of claim 6, wherein said rechargeable battery cell is a lithium cell.

11. An electrical hand tool device comprising the rechargeable battery pack of claim 6 for supplying electrical energy to an electric motor of the electrical hand tool device, wherein the rechargeable battery pack is detachably connected or locked to the electrical hand tool device.
